(19) United States
(12) Patent Application Publication
(10) Pub. No.: US 2004/0167790 A1
(43) Pub. Date: Aug. 26, 2004

(54) Method of conducting business in a system requiring frequency up-dates and corrections

(76) Inventor: Robert de Grasse, Bellevue, WA (US)

Correspondence Address: JENSEN + PUNTIGAM, P.S., SUITE 1020, 2033 6TH AVE, SEATTLE, WA, 98121, US

(21) Appl. No.: 10/374,156

(22) Filed: Feb. 24, 2003

(51) Int. Cl. G06F 17/60

(52) U.S. Cl. 705/1

(57) ABSTRACT

A method of doing business which utilizes a hierarchical database wherein the method utilizes quality feedback loops and data packets, enabling ongoing data input, verification and change.

### TECHNICAL FIELD

This invention relates to a method of conducting business wherein it is required that the data which drives the business method be constantly updated and corrected, and more particularly to a method wherein the initial hierarchical data need not be laboriously gathered and input to make the system workable.

### BACKGROUND OF THE INVENTION

Typically, when one sets up a management program, such as a preventative maintenance program, the laborious time-consuming gathering of all the pertinent information about the various units and/or modules which comprise the total system, entering all of the pertinent data into a central computer bank, and appropriately segregating the material and distributing it to those people who actually perform the maintenance while making sure that the necessary data and instructions are timely delivered, greatly delays the implementation of the program. Although the preventative maintenance program will be used as an example of the present business method, it is to be understood that the inventive method is not as limited.

Prior art known to the present inventor includes:

U.S. Pat. No. 5,630,072, which discloses an automatic process for location tracking and identification and recording of object units and their relative location in conjunction with the traditional hierarchical coded location addressing, to directly support tracking, configuration, management of diversified hierarchical object in its systems and their components.

U.S. Pat. No. 5,870,733 granted to Bass et al February 1999 discloses an automated system and method for providing access data concerning items of business property which includes a master database; an accessor provides an access request. The manager receives the access request and in response provides the accessor with access data concerning the item.

U.S. Pat. No. 5,970,476 granted to Fahey November 1999 discloses information storage, processing, and reporting system for tracing product data, which includes data storage for entries related to a product family. The data is received in a data warehouse, cataloged where the system indexes the data related to a product family. The data tables are used for grouping indexed data.

U.S. Pat. No. 6,189,004 granted to Rassen et al deals with data marketing methodologies.

U.S. Pat. No. 6,199,059 granted to Dahan et al Mar. 6, 2001 discloses a three-tiered virtual classification model including search schemes, object hierarchy and databases to find components.

U.S. Pat. No. 6,411,936 granted to Sanders Jun. 25, 2002 discloses an enterprise value enhancement system, method, and apparatus that uses an enhancement model based on planning loop structures.

WO 01/71607 discloses a system for an overall provision for maintenance and technical services. The system includes various resources integrated to the knowledge database.

WO 01/88814 discloses a database system for selection and purchase of equipment parts utilizing a drill-down method where sequential layers of the database information are presented to a potential purchaser.

WO 2067175 appears to disclose a business-to-business multi-level communication system accessed by the Internet and by the systems feedback which is continuously monitored and analyzed by the system.

### DISCLOSURE OF THE INVENTION

With the above-noted prior art in mind, it is a feature of the present invention to provide a business method typically based upon hierarchical data wherein the labor intensive data collection and input is virtually eliminated, allowing early deployment and increased productivity. The data structure is layered, allowing phased and systematic implementation, thereby allowing minimally skilled staff access to the field data to verify, collect and modify the data as necessary. The data extraction upload uses standardized data packets that return data that is normally reported back, incrementally correct data and add data which is not currently in the scope, and includes an automated method for updating regularly modified data as opposed to a manual input. This method starts with the general information and moves to more detailed data over time.

It is another feature of the present invention that the hierarchical data requirements are broken out into logical layers and the hierarchical data pyramids which have mandatory sequencing are removed beyond the minimum data layer requirement, following a generalized collection of input of data without interrupting the functionality of the front-end software, allowing initial implementation using generalized data information.

### BRIEF DESCRIPTION OF THE DRAWINGS

FIG. 1, is a flow chart showing a traditional preventative maintenance program;

FIG. 2, is a flow chart showing a preventative maintenance program utilizing the current invention.

### BEST MODE FOR CARRYING OUT THE INVENTION

Although the best mode described is in relationship to a preventative maintenance program, it is to be understood that the approach may be used in many existing industry practices as to hierarchical data conditions, such as asset cataloging/inventorying, program management, warranty program management, IT hardware program management, financial review and auditing and accelerated project development management.

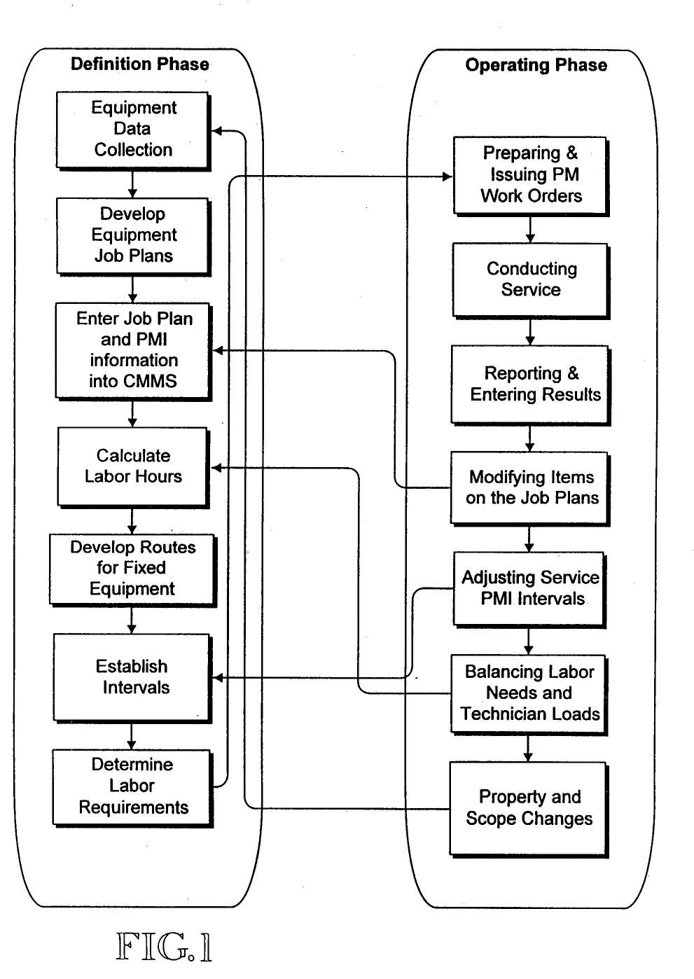

FIG. 1 illustrates a traditional preventative maintenance program as a flow chart for simplicity. As seen in a flow chart, the program includes a Definition phase and an Operating phase. The Definition phase includes the collection of the highest level of detailed data need as identified.

In a traditional program, the particular information for all equipment to be inspected is collected so that a basic program can be developed and launched. The minimum required information between different computerized maintenance management systems differs from application to application, but the level of detail is similar and very onerous. This equipment data collection is vast and labor-intensive and typically includes identifying and listing all equipment and systems having any preventative maintenance associated with them. This step requires identifying the skills needed to conduct the field surveys and identifying the method and means of data collection. It is noted that the collection of data is often problematic and time consuming, since questions need to be answered, such as what information is needed, how is the information to be collected, and how is the information tabulated and collated, to say nothing of the factor as to how is the information verified and validated.

Typically, teams of surveyors are sent out to inspect the equipment on-site to collect equipment-specific information, equipment number, manufacturer, make, model, serial number, spare and consumable parts information. The surveyors need to be skilled enough to identify equipment and know specifically how to extract the necessary information. Once the data is considered “clean” and adequate, the data is entered into the computerized maintenance management system, which normally would require the hierarchical data being manually input into the system and this would normally require a person who is also familiar with the computerized maintenance management system data entry so the database is less likely to be corrupted. Once the equipment data collection has been completed and entered, it is necessary to develop a comprehensive maintenance task list for each piece of equipment, including each inspection activity, the frequency of each inspection in time to complete the task list, as well as the materials required to complete the task, including the tools and parts, and further including coordination as to where and when the item activity is to be conducted. Once collated, these tasks are referred to as the equipment's “job plans”.

All of the information collated for the job plans preventative maintenance inspections now needs to be entered into the computerized maintenance management system, a process, which is predominately, if not completely, a manual data entry process. It is to be noted that even in the leading computerized management systems, the ability to duplicate and reuse similar information already entered is labor-intensive, cumbersome and sometimes not even possible.

Once, the “job plan” and preventative maintenance inspection (PMI) is entered into the computerized maintenance management system, it is necessary to calculate the entire number of labor hours required, by trade type, for the entire list of PMI activities. The time required for each task must be estimated. It is also necessary to establish the time that would be allocated for each service/site. This task is important and must be established before the specifics of the labor is determined, as it will drive the quantities of labor. It is now necessary to develop routes for the trade technician to use during the preventative maintenance inspections to avoid backtracking and establish intervals between job plans and further refine the labor requirements.

Once the definition phase is completed, then the operating steps including preparing and issuing the preventative maintenance work order must be performed, since the master schedule prescribes the week-to-week plan for the preventative maintenance services to be performed. The technician uses the PMI tasks to conduct the service when the service is scheduled.

In general, the generation of the preventative maintenance work orders is conducted in the computerized maintenance management system and the work orders are issued. The dissemination of orders is conducted in several ways in a traditional preventative maintenance program, including paper-generated work orders, which are hand delivered. If hand delivery is not feasible, in that the technician is not located in the same physical vicinity, then the orders are faxed or mailed to the location. In some cases where the business practices have been set up, preventative maintenance work orders are e-mailed to an account that is used to disseminate the particular orders.

Today, there are hand-held devices that have direct ties to the computerized preventative management system industry and allow work orders to be pushed and pulled electronically. These devices range from personal data assistants, cell phones and pocket PCs. Although this type of interface is becoming more common, it is still not well used because of the constant initial set up and the physical equipment required.

Following the performance of the actual inspections and preventative maintenance tasks, i.e. conducting the service, the secondary process of conducting inspections to identify deficiencies and reporting back these deficiencies such that the findings are translated into work orders to correct the deficiencies during the subsequent inspections. In a traditional preventative maintenance program, this information must be reported back to the location where the manual data entry takes place, although some of the hand-held solutions allow the direct reporting of this information to the computerized maintenance management system database.

The preventative maintenance inspections check list/tasks should be a living document, which should be modified as factors change. The changes should be made to ensure that the job plan remains accurate to achieve the goals of the preventative maintenance program. This task is a manual process, as is the task of adjusting schedules for appropriate intervals of service. This results in an annual process typically completed by managers, then documented and manually entered into the computerized maintenance management system.

As soon as the adjustments are made, then the needs are constantly adjusted, including the labor factor as well as other influences, such as external projects and high demand work orders. In the traditional preventative maintenance program, changes in labor and workloads are reported back and manual changes are made to the computerized maintenance management system software to reflect the changes. Again, a manual input is required.

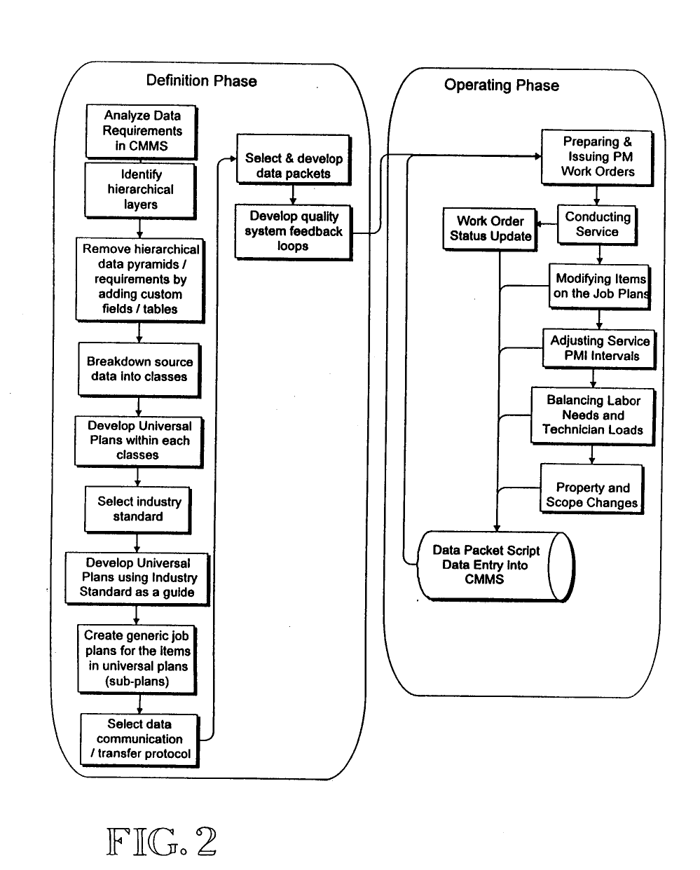

In contrast to the traditional hierarchical approach, the current inventive business methodology will be set out hereinafter and specifically described with respect to FIG. 2, but it is to be noted that the methodology can be launched very quickly and eliminates detailed field surveys and/or data collection entry, either all together or at the front end of the deployment of the program. The current business methodology has immediate productivity with systems and field staff and greatly simplifies the collection and input of data. The data structure collection identification task is layered to allow phased and systematic implementation, and is layered in such a way that it allows a minimally skilled staff which has access to the field data to verify, collect and modify the data input as necessary in a very simple and direct manner. The data extraction upload is conducted using programmed scripts into and from standardized data packets, which facilitates the currency of the data. The returned data packets are used to return data, incrementally correcting data, adding data that is not yet collected, and includes an automated method for updating other regularly modified data that would normally need manual input into the system. This method of data feedback can be used in conjunction with the traditional manual interface along with the existing interfaces as well as with newly developed interfaces specifically tailored for these data packets. The current inventive method starts with the most general information and moves to more detailed data over time, whereas the more traditional method requires the collection of detailed data and moves to the general data. Since the current business methodology has a brand applicable data communication transfer protocol system, it allows a multitude of input mediums and sources, and the same protocol can be collected and sent from many different mediums and platforms. The simple data protocol is delivered and uploaded using automatic scripts based upon which data packet is received. This data protocol is totally independent from the operating system and is capable of being delivered via a number of mediums, although the current methodology does not exclude the traditional interface or other data transfer methodologies.

It is to be understood that the data packets are scripted directly into the database tables, eliminating manual interface, particularly when received from third party organizations, which greatly reduces data entry errors and duplication.

As pointed out hereinabove, it is typical in traditional hierarchical data systems that the highest level of data detail is needed to be identified, collated and entered into the system and used for tracking. Most of the traditional data systems have centralized access points to the system, even though many systems allow decentralized access the data, and most require some form of connection to the server and database, which is not necessary in the current methodology.

The present business method contains a quality feedback loop system that performs many functions, including a data collection vehicle, wherein the details are seamlessly collected in a very short cycle time over any desired sequence of time. One of the fundamental components of the present methodology is to establish data and communication protocols integrated with quality feedback loops, allowing any number of third party groups as well as internal staff to receive and supply data packets, thus providing information without direct connection to the central servers. The current methodology allows easy monitoring of the quality of the data being returned. Thus, consistency and changes can be compared across the entire data population. The delete/add/change level across many layers has many advantages over the traditional system by having the information flow through data packets. Consistency in changes can be compared across the entire population of the data packet. The changed levels across many technicians will reveal issues/problems based upon the statistical level with other technicians

Referring to FIG. 2, the current business method steps are shown in a flow chart. In the current system, the hierarchical data requirements are broken into logical layers to achieve the necessary levels of detail. The minimum system and business practice data layers are noted and the mandatory data requirements identified.

The traditional hierarchical data pyramids, which have mandatory sequencing, are removed beyond the minimum data requirements field and tables are added within the databases to allow the generalized collection and input of data without interrupting the functionality of the front-end software. If desirable, these added fields and tables could be migrated into the original detail tables and fields at a later time. These fields/tables allow the software to function as if the mandatory data sets were present in its hierarchical data structure. This allows the initial launch and implementation using generalized data information without the details required in a traditional hierarchical data structure, thus allowing it to be launched very quickly. The level of detail is more general and less detailed. The integration of the detailed data using existing business practices minimizes added process labor time. The integration of the detailed data is achieved with a quality system feedback loop (explained hereinafter) over time, and the level of the data achieved using the current method meets and often exceeds that of a traditional approach. In the inventive business practice, the data is analyzed and broken down into classes of data at the highest level of general tracking. These classes should map the manner in which the business tracks information. Too much detail is not recommended at this stage, since detail can be tracked and captured in other stages of data collection. The universal plans within classes developed should be business or industry-driven; and in the case of preventative maintenance programs, the universal plans are divided by building systems or functions based on the highest level of data acceptable (i.e., mechanical/plumbing, electrical, fire/life/safety, etc.) to meet the business application and ease the implementation into deployment. Mechanical systems is typically one vendor contractor, whereas electrical is a major building system, but separate skill sets, fire/life/safety is split out for similar reasons to allow easy tracking of the regularatory compliance issues. A generic industry standard is selected and identified that meets an acceptable level of detail sought within the universal plan. The industry standards selected should have major groupings and specificity at a generally accepted industry level. The example described herein is the RS Means generic equipment preventative maintenance job plans and associated prospective tasks. These RS Means job plans are already broken out into major categories or sub-plans within the universal plan and are developed using industry standards. One approach would be to use the Pareto approach, which identifies what makes up 80% of the cases in a given set of data being examined. It is not necessary to have statistical or accurate data on the population, and a best guess will be sufficient, because the quality feedback loops will correct the guesses. A standard must be selected for the communication transfer protocol, and one that will easily integrate any number of third party organizations directly into the information system and the data transfer protocol negates the traditional interface with data servers eliminating manual data entry. The transfer protocol further allows third party organizations to maintain their own business practices, and yet still be fully integrated with the reception/supply of necessary data. This protocol reduces the internal redundant/duplicate of data entry without added “software seed costs” and is achieved without the necessity of skilled staff, thus reducing or eliminating the manual data entry errors.

Data packets are selected and developed which create a simple change-add-delete process for key data sets, and thus the upload of data packets is achieved without the specific knowledge of the software hierarchical input idiosyncrasies. The specialized and trained staff that handles the software is eliminated for the most part. This allows the remote sites, staff without server/client continuity and third party organization integration into the change-delete-information without a server. It is to be understood that the packet return cycle period is flexible and can be changed at any time to meet the needs, allowing the currency of the data to be improved with each separate vendor as that vendor is ready and capable of handling the alteration. The delivery of the data packets can be achieved through a variety of methods, including but not limited to storage medium, e-mail, web upload and peer-to-peer connections, etc.

Quality feedback loops must be developed, and this done by identifying the source of all the data required, mapping the data through the hierarchical layers and through universal plans, sub-plans and classes, and further identifying people that regularly interact with the data and where they interact in the mapping. These people should have a basic knowledge of the information that is being tracked, and preferably be accountable for the information being tracked. Minimum data layers need to be identified and the people that interact with these layers, which have an overlap and then the specific data that these people have the capability of identifying in these minimum data layers, must be designated. The feedback loop should be mapped such that they allow these people to verify information (“add-change-delete”). The collection and integration of data is conducted with quality feedback loop systems that correct and increase these details over one or more cycles. These loops are integral to the overall business methodology.

As can be seen, the current methodology allows an early start-up and create a plan without the heavy front-end requirement and manual data entry.

The general information is collected by the people normally and regularly at the site, and the detailed information is collected later when and at the time that the skilled/technically capable people visit the site. Differentiating from the traditional approach, the detailed information does not need to be collected t the initiation by the survey teams, but may be collected later and fed into add-change-delete feedback loops through the same data packets.

1. A computerized method of administering a multi-faceted business operation which needs ongoing attention and follow-up, utilizing a hierarchal data system, comprising the steps of:
a) defining the facets and their components;
b) launching the program and systems using generalized data;
c) entering statistical data regarding the facets and the components during the first routine visit to each component;
d) forwarding the data to a central control program, thereby adding new data and revising previously stored data; and
e) compiling said data and forwarding the data to the appropriate recipient on a predetermined or ad hoc schedule.

2. A method of claim 1, wherein the method is used for preventative maintenance.

3. A method of claim 1, wherein the method is used for warranties.

4. A method of claim 1, wherein the method is used for project management.

5. A method as in claim 1, wherein the data may be entered remotely.

6. A method as in claim 1, wherein the data may be forwarded to a remote recipient.

7. A method as in claim 1, wherein the forwarding is done electronically.

8. A method as in claim 1, wherein the method operates independently of the operating system.

9. A method as in claim 1, wherein the data input is scripted in database table without affecting the operation of the system.

10. A method as in claim 1, including a quality feedback loop, including data and communication protocol, allowing input and monitoring by third parties.

11. A method of claim 1, wherein the method is used for energy conservation measures management.
